(19) United States
(12) Patent Application Publication
(10) Pub. No.: US 2015/0103560 A1
(43) Pub. Date: Apr. 16, 2015

(54) UTILITY WORKING LIGHT APPARATUS

(71) Applicant: Bi Xin Li, Foshan (CN)

(72) Inventor: Bi Xin Li, Foshan (CN)

(21) Appl. No.: 14/499,134

(22) Filed: Sep. 27, 2014

(30) Foreign Application Priority Data
Oct. 11, 2013 (CN) 201320626063.9

(51) Int. Cl. F21V 21/14; F21V 15/01

(52) U.S. Cl. CPC F21V 21/14; F21V 15/01
USPC 362/646; 362/362

(57) ABSTRACT

A lighting apparatus comprising a housing, wherein the housing is positioned between a front cover unit and a rear cover unit, wherein the front cover unit is comprised of a first connecting apparatus and the rear cover is comprised of a second connecting apparatus wherein the first connecting apparatus is attached to the first end of said housing and the second connecting apparatus is attached to the second end of said housing wherein the first connecting apparatus can rotate against the front cover and the second connecting apparatus can rotate against the rear cover wherein the housing is comprised of a lighting apparatus wherein the front cover is further comprised of a first magnetic unit and the rear cover is further comprised of a second magnetic unit.

### INCORPORATION BY REFERENCE

This application claims the benefit of Chinese patent application No. 201320626063.9, filed Oct. 11, 2013, which is incorporated herein by reference in its entirety.

### FIELD OF THE INVENTION

The present invention generally relates to lighting technology, and, more particularly, a work light.

### BACKGROUND OF THE INVENTION

Work lights are widely used in automotive repair shops and other repair settings and construction settings. Such work lights are often in a form that can alternatively be handheld or hung from a suitable elevated object such as a raised automobile hood.

Currently, on the market, most of the work lights are fixed angle light source; that is, the lights are not rotatable. A rotatable work light is convenient and advantageous where it is hung or affixed to a suitable object, and yet the user needs light on the adjacent areas. With a rotatable work light, the user can conveniently and quickly rotate the light source to a desired angle and have the light shine on the target areas, instead of repositioning the work light.

### OBJECT OF THE INVENTION

Accordingly, one objective of this invention is to provide a rotatable work light.

Another objective of this invention is to provide a convenient work light.

Yet another objective of this invention is to provide a versatile work light.

### SUMMARY OF THE INVENTION

In one aspect, A lighting apparatus comprising a housing, wherein the housing is positioned between a front cover unit and a rear cover unit, wherein the front cover unit is comprised of a first connecting apparatus and the rear cover is comprised of a second connecting apparatus wherein the first connecting apparatus is attached to the a first end of the housing and the second connecting apparatus is attached to the second end of the housing wherein the first connecting apparatus can rotate against the front cover and the second connecting apparatus can rotate against the rear cover wherein the housing is comprised of a lighting apparatus wherein the front cover is further comprised of a first magnetic unit and the rear cover is further comprised of a second magnetic unit. In one embodiment, the lighting apparatus is comprised of an aluminum housing and a convex lamp shade and a light circuit board. In one embodiment, the light circuit board is a LED light circuit board. In one embodiment, the first magnetic unit and the second magnetic unit attach the first cover and the second cover to a metal surface and allow the housing to be rotated against the first cover and the second cover. In one embodiment, the first cover is comprised of a USB charging connector. In one embodiment, the first cover is further comprised of a circuit board wherein the circuit board controls the lighting apparatus. In one embodiment, the rear cover is further comprised of a retractor. In one embodiment, the rear cover is further comprised of a lever wherein the lever is capable of sliding against the rear cover and adjust the retractor's orientation. In one embodiment, the first connecting apparatus is comprised of a first rotatable cover wherein the first rotatable cover attaches the front cover to the first connecting apparatus wherein the first rotatable cover allows the front cover to rotate against the first connecting apparatus. In one embodiment, the first connecting apparatus is comprised of a second rotatable cover wherein the second rotatable cover attaches the rear cover to the second connecting apparatus wherein the second rotatable cover allows the rear cover to rotate against the second connecting apparatus.

### BRIEF DESCRIPTIONS OF THE DRAWINGS

FIG. 1 is a schematic exploded view of an exemplary work light.

FIG. 2 is a front view of an exemplary work light.

FIG. 3 is a left side view of an exemplary work light.

FIG. 4 is a right side view of an exemplary work light.

### DETAILED DESCRIPTION OF THE INVENTION

The following detailed description of the preferred embodiments presents a description of certain specific embodiments as examples of a plurality of ways to practice this invention. As such, one may practice the present invention in a multitude of different embodiments as defined and covered by the claims.

In some instances, certain features are described in less or more detail. The level of detail associated with each of the elements or features should not be construed to qualify the novelty or importance of one feature over the others.

Certain marks referenced herein may be trademarks, whose use is to provide an enabling disclosure by way of example and shall not be construed to exclusively limit the scope of the disclosed subject matter to material associated with such marks.

References in this specification to “an embodiment”, “one embodiment”, “one or more embodiments” or the like, simply mean that the particular element, feature, structure or characteristic being described is in at least one embodiment of the disclosed subject matter. The occurrences of such phrases do not necessarily refer to the same embodiment, nor do they necessarily to mutually exclusive embodiments with respect to the discussed features or elements.

Various exemplary embodiments disclosed herein are directed to a work light that is convenient, versatile, and rotatable.

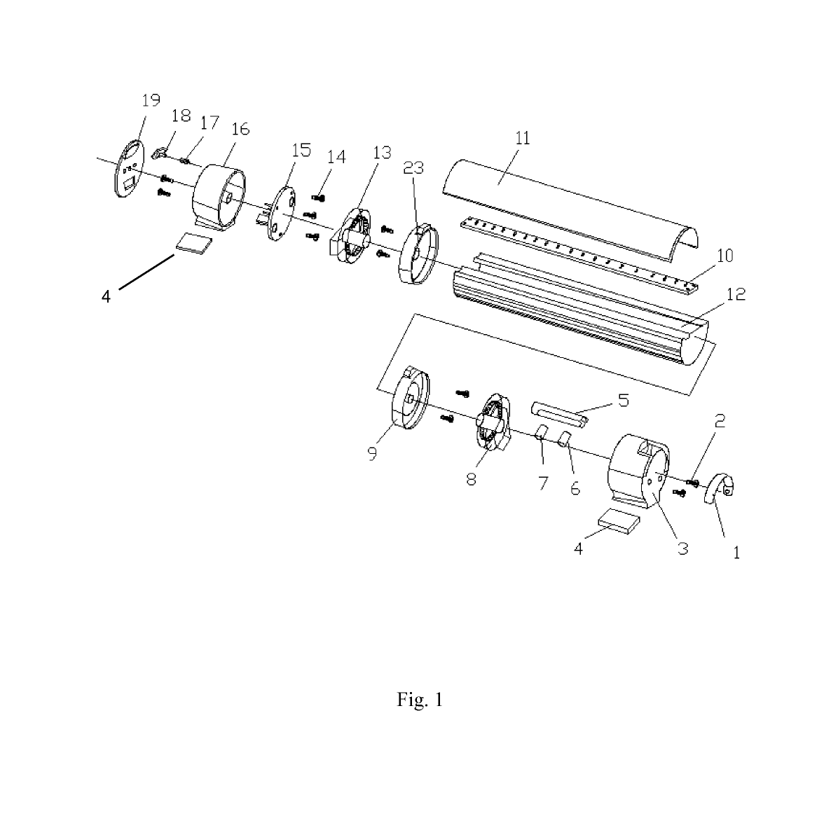

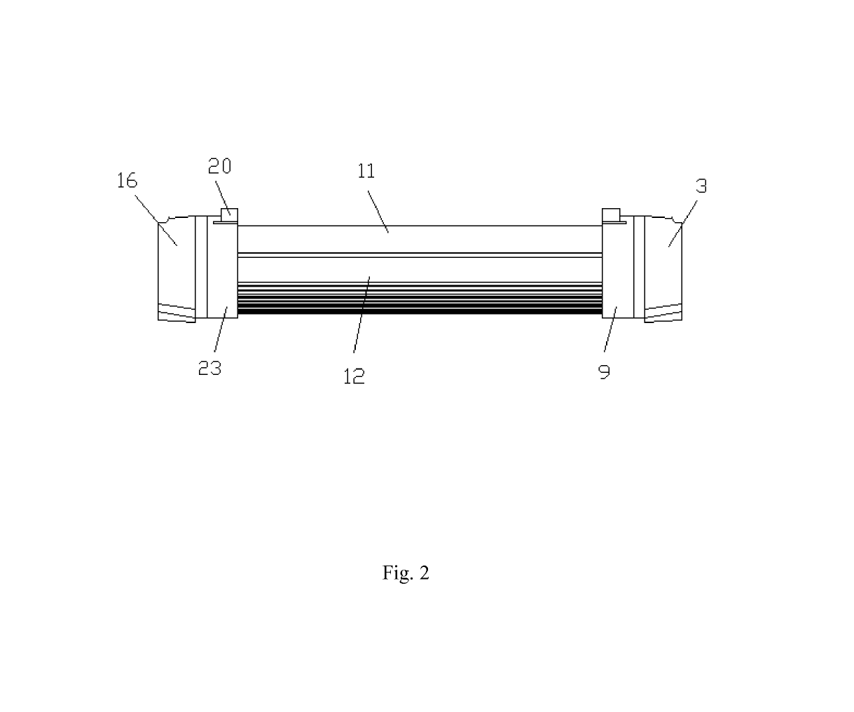

Referring to FIGS. 1 and 2, in one embodiment, a work light comprises a convex longitudinal aluminum housing 12, that comprises a front and rear ends, which are covered by a front cover 16 and rear cover 3. The aluminum housing 12 houses an aluminum light board 10, which is positioned along the longitudinal center of the aluminum housing. The aluminum light board 10 is covered by a convex lamb shade 11 along the longitudinal axis. The aluminum housing 12 and the shade 11 are two compliment parts of a cylindrical shape and, when assembled, form a cylinder. The work light further comprises a control boards 15 that is disposed inside the cavity of the front cover 16, and attached to the cover with screws 14. The cavity of the front cover 16 is capped by one side of a rotatable cover 13, whose other side is attached to a second connection member 23. The connection member 23 comprises a shallow cavity where the front end of the housing 12, and lamb shade 11 are disposed.

Still referring to FIGS. 1 and 2, in one embodiment, the rear cover 3 also comprises a rotatable cover 8, one side of which caps the cavity of the rear cover 3, and the other side connects to a first connection member 9. Additionally, the rear cover 3 comprises a rod shape lever 5, that is provided with longitudinal grooves. The lever 5 slides in and out of the rear cover 3 through a hole on the end of the rear cover 3, guided by shaft 6 and pin 7, and connected to a curved retractor 1, such that when the lever 5 is pushed outward away from the rear cover 3, the retractor 1 is also pushed out from a curved groove which is positioned on the exterior end of the end cover 3, and when the lever 5 is pushed inward toward the rear cover 3, the retractor 1 is pushed back toward the curved groove and disposed in the groove flush with the exterior end of the end cover 3.

Still referring to FIGS. 1 and 2, in one embodiment, the front and end covers 16 and 3 each further comprises a magnetic block 4, which can be used to attach the work light to a fixed metal structure, while the housing 12, light board 10, and lamb shade 11 rotate as a unit to a desired angle.

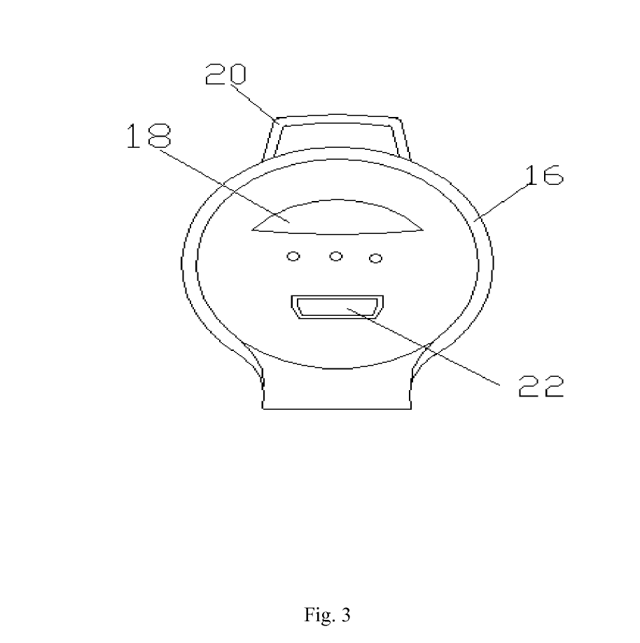

Referring to FIGS. 1 and 3, in one embodiment, the front cover 16 comprises a button 18, a facade 19, and a USB jack 22, which are all disposed on the exterior end of the front cover. The facade 19 is attached to the front cover 16 with screws, and has openings for the button 18 and USB jack 22. The button 18 connects to a spring 17, which in turn connects to the front cover 16. The USB jack 22 is disposed within the cavity of the front cover 16, connected to the control board 15, and exposed externally on the facade 19.

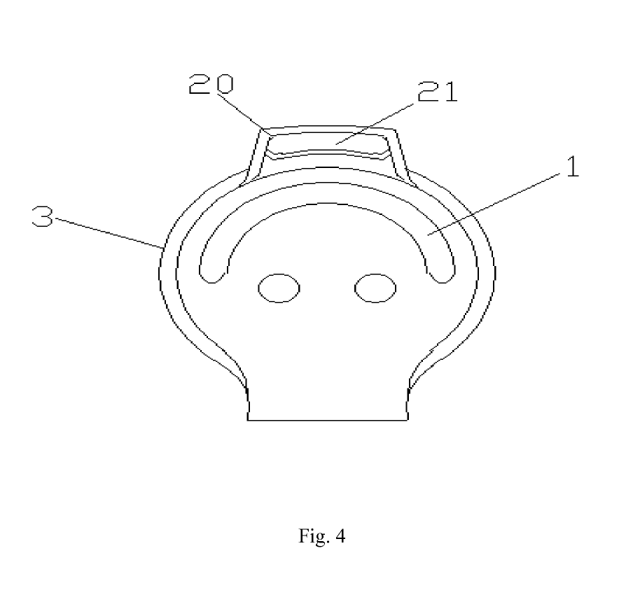

Referring to FIGS. 3 and 4, in one embodiment, the first connection member 9 and second connection member 23 each has a convex arch 20 disposed on the outer perimeters of connection members 9 and 23. The convex arch 20 comprises a through hole 21, which can be used to pass a rope through and hang the work light up.

Although specific embodiments have been illustrated and described herein, it will be appreciated by those of ordinary skill in the art that any arrangement that is calculated or designed to achieve the same purposes may be substituted for the specific embodiments shown. Many adaptations of the disclosure will be apparent to those of ordinary skill in the art. Accordingly, this application is intended to cover any adaptations or variations of the disclosure.

1. A lighting apparatus comprising a housing, wherein said housing is positioned between a front cover unit and a rear cover unit, wherein said front cover unit is comprised of a first connecting apparatus and said rear cover is comprised of a second connecting apparatus wherein said first connecting apparatus is attached to said a first end of said housing and said second connecting apparatus is attached to said second end of said housing wherein said first connecting apparatus can rotate against said front cover and said second connecting apparatus can rotate against said rear cover wherein said housing is comprised of a lighting apparatus wherein said front cover is further comprised of a first magnetic unit and said rear cover is further comprised of a second magnetic unit.

2. The apparatus of claim 1 wherein said lighting apparatus is comprised of an aluminum housing and a convex lamp shade and a light circuit board.

3. The apparatus of claim 2 wherein said light circuit board is a LED light circuit board.

4. The apparatus of claim 1 wherein said first magnetic unit and said second magnetic unit attach said first cover and said second cover to a metal surface and allow said housing to be rotated against said first cover and said second cover.

5. The apparatus of claim 1 wherein said first cover is comprised of a USB charging connector.

6. The apparatus of claim 1 wherein said first cover is further comprised of a circuit board wherein said circuit board controls said lighting apparatus.

7. The apparatus of claim 1 wherein said rear cover is further comprised of a retractor.

8. The apparatus of claim 7 wherein said rear cover is further comprised of a lever wherein said lever is capable of sliding against said rear cover and adjust said retractor's orientation.

9. The apparatus of claim 1 wherein said first connecting apparatus is comprised of a first rotatable cover wherein said first rotatable cover attaches said front cover to said first connecting apparatus wherein said first rotatable cover allows said front cover to rotate against said first connecting apparatus.

10. The apparatus of claim 1 wherein said first connecting apparatus is comprised of a second rotatable cover wherein said second rotatable cover attaches said rear cover to said second connecting apparatus wherein said second rotatable cover allows said rear cover to rotate against said second connecting apparatus.
